(19) United States
(12) Patent Application Publication
(10) Pub. No.: US 2026/0336486 A1
(43) Pub. Date: Oct. 29, 2026

(54) Seat

(71) Applicants: Hyundai Motor Company, Seoul (KR); Kia Corporation, Seoul (KR); Hyundai Transys Inc., Seosan-si (KR)

(72) Inventors: Mu Young Kim, Hwaseong-Si (KR); Han Kyung Park, Hwaseong-Si (KR); Jae Hoon Cho, Hwaseong-Si (KR); Won Yeong Lee, Hwaseong-Si (KR); Yun Soo Park, Hwaseong-Si (KR)

(21) Appl. No.: 19/401,056

(22) Filed: Nov. 25, 2025

(30) Foreign Application Priority Data
Apr. 25, 2025 (KR) 10-2025-0054699

(51) Int. Cl. B60N 2/30; B60N 2/10

(52) U.S. Cl. CPC B60N 2/3009; B60N 2/10

(57) ABSTRACT

Disclosed is a seat that includes: a leg frame; a cushion frame rotatably coupled to a first portion of the leg frame; a back frame rotatably coupled to a second portion of the leg frame; a connection link comprising: a first side rotatably coupled to the cushion frame, and a second side rotatably coupled to the back frame; and a cushion link rotatably coupled to the leg frame and the cushion frame.

### CROSS-REFERENCE TO RELATED APPLICATION

This application claims priority to and the benefit of Korean Patent Application No. 10-2025-0054699 filed in the Korean Intellectual Property Office on Apr. 25, 2025, the entire contents of which are incorporated herein by reference.

### TECHNICAL FIELD

The present disclosure relates to a seat, and more particularly, to a seat capable of changing its posture.

### BACKGROUND

Vehicle seats may be designed to focus on the comfort of the occupants who sit on the seats. However, for multipurpose vehicles, such as purpose-built vehicles (PBVs) with various utilization possibilities, the seats may be designed with not just seating comfort in mind but also to serve other purposes.

For example, it may be necessary to design the seat so that the seat occupies a minimum volume when large items are to be loaded into the vehicle and transported. Thus, it may become a challenge to balance the utility of a vehicle seat with the utilization of the internal space of the vehicle.

### SUMMARY

An object of the present disclosure is to propose a new structure capable of minimizing a volume of a space occupied by a seat for a vehicle.

According to one or more example embodiments of the present disclosure, a seat may include: a leg frame; a cushion frame rotatably coupled to a first portion of the leg frame; a back frame rotatably coupled to a second portion of the leg frame; a connection link including a first end portion rotatably coupled to the cushion frame and a second end portion rotatably coupled to the back frame; and a cushion link rotatably coupled to the leg frame and the cushion frame.

The cushion frame may include: a cushion frame body region and a cushion frame hinge. The cushion frame hinge may include: a first end extending from a side of the cushion frame body region, and a second end rotatably coupled to the leg frame.

The cushion link may include a first cushion link. The first cushion link may include: a first end portion rotatably coupled to the cushion frame; and a second cushion link. The second cushion link may include: a first end portion rotatably coupled to the leg frame, and a second end portion rotatably coupled to the first cushion link.

The first cushion link and the second cushion link may be configured to rotate such that, based on the seat being in an open position, the first end portion of the second cushion link is positioned more rearward relative to the first end portion of the first cushion link.

The first cushion link and the second cushion link may be configured to rotate such that, based on the seat being in a closed position, the first end portion of the second cushion link is positioned more forward relative to the first end portion of the first cushion link and the cushion frame extends in a vertical direction.

The first cushion link and the second cushion link may be configured to rotate such that, based on the seat being in an open position, a second end portion of the first cushion link and the second end portion of the second cushion link are positioned below the cushion frame hinge.

The first cushion link and the second cushion link may be configured to rotate such that, based on the seat being in a closed position, the second end portion of the first cushion link and the second end portion of the second cushion link are positioned above the cushion frame hinge and the cushion frame extends in a vertical direction.

The first cushion link and the second cushion link may be configured to rotate such that, based on the seat being in an open position, the first end portion of the connection link is positioned more rearward relative to the first end portion of the first cushion link.

The first cushion link and the second cushion link may be configured to rotate such that, based on the seat being in a closed position, the first end portion of the connection link is positioned below the first end portion of the first cushion link and the cushion frame extends in a vertical direction.

The first cushion link and the second cushion link may be configured to rotate such that, based on the seat being in an open position, the first end portion of the connection link juts forward relative to the leg frame.

The first cushion link and the second cushion link may be configured to rotate such that, based on the seat being in a closed position, the first end portion of the connection link overlaps the leg frame in a lateral direction and the cushion frame extends in a vertical direction.

The cushion frame hinge may be positioned above and more rearward relative to the first end portion of the second cushion link.

The back frame may further include: a back frame body region; and a back frame extension that extends from an end portion of the back frame body region. The back frame extension may include a hinge portion rotatably coupled to the connection link.

The first cushion link and the second cushion link may be configured to rotate such that, based on the seat being in an open position, a first angle, between the back frame extension and a first line that connects the first end portion of the connection link and the second end portion of the connection link, is greater than a second angle, between a second line that connects the first end portion of the first cushion link and a second end portion of the first cushion link and a third line that connects the first end portion of the second cushion link and the second end portion of the second cushion link.

The first cushion link and the second cushion link may be configured to rotate such that, based on the seat being in a closed position, a first angle, between the back frame extension and a first line that connects the first end portion of the connection link and the second end portion of the connection link, is less than a second angle, between a second line that connects the first end portion of the first cushion link and the second end portion of the first cushion link and a third line that connects the first end portion of the second cushion link and the second end portion of the second cushion link.

The seat may further include: a recliner assembly configured to selectively fix the back frame.

The recliner assembly may include: a recliner provided in a region to which the back frame is rotatably connected; a recliner lever that includes a first end portion coupled to the recliner and configured to be rotatable to unlock the recliner; and a return spring configured to provide an elastic force for rotating the back frame forward.

The seat may further include: a recliner configured to rotate, based on an elastic force, the back frame such that a first end portion of the back frame juts forward relative to a second end portion of the back frame. The back frame and the cushion frame may be coupled such that the rotation of the back frame causes a rotation of the cushion frame to dispose the back frame parallel to the cushion frame. The cushion link may include a gas damper.

According to one or more example embodiments of the present disclosure, a seat may include: a leg frame; a cushion frame rotatably coupled to a first portion of the leg frame; a back frame rotatably coupled to a second portion of the leg frame; a connection link that includes a first end portion rotatably coupled to the cushion frame and a second end portion rotatably coupled to the back frame; and a cushion link rotatably coupled to the leg frame and the cushion frame. The back frame and the cushion frame may be coupled such that a rotation of the back frame causes a rotation of the cushion frame to dispose the back frame parallel to the cushion frame.

The seat may further include: a recliner configured to rotate, based on an elastic force, the back frame such that a first end portion of the back frame juts forward relative to a second end portion of the back frame.

### BRIEF DESCRIPTION OF THE DRAWINGS

FIG. 1 is a perspective view of an example seat in a seating position.

FIG. 2 is a perspective view of an example seat in a folded position.

FIG. 3 is a perspective view illustrating a framework and links of an example seat in a seating position.

FIG. 4 is a side view illustrating a positional relationship between a framework and links of an example seat in a seating position.

FIG. 5 is a perspective view illustrating a framework and links of an example seat in a folded position.

FIG. 6 is a side view illustrating a positional relationship between a framework and links of an example seat in a folded position.

### DETAILED DESCRIPTION

Hereinafter, one or more example embodiments of the present disclosure will be described in detail with reference to the illustrative drawings. In giving reference numerals to constituent elements of the respective drawings, it should be noted that the same constituent elements will be designated by the same reference numerals, if possible, even though the constituent elements are illustrated in different drawings. Further, in the following description of the example embodiment(s) of the present disclosure, a detailed description of related publicly-known configurations or functions will be omitted when it is determined that the detailed description obscures the understanding of the present disclosure.

In addition, the terms first, second, A, B, (a), and (b) may be used to describe constituent elements of the example embodiment(s) of the present disclosure. These terms are used only for the purpose of discriminating one constituent element from another constituent element, and the nature, the sequences, or the orders of the constituent elements are not limited by the terms. Further, unless otherwise defined, all terms used herein, including technical or scientific terms, have the same meaning as commonly understood by those skilled in the art to which the present disclosure pertains. The terms such as those defined in commonly used dictionaries should be interpreted as having meanings consistent with meanings in the context of related technologies and should not be interpreted as ideal or excessively formal meanings unless explicitly defined in the present application.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

Hereinafter, a seat (e.g., an adjustable vehicle seat) will be described with reference to the drawings.

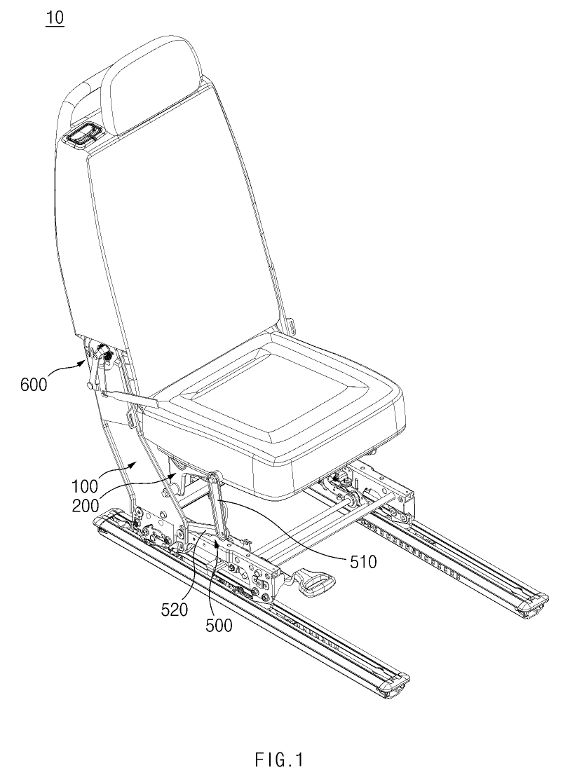

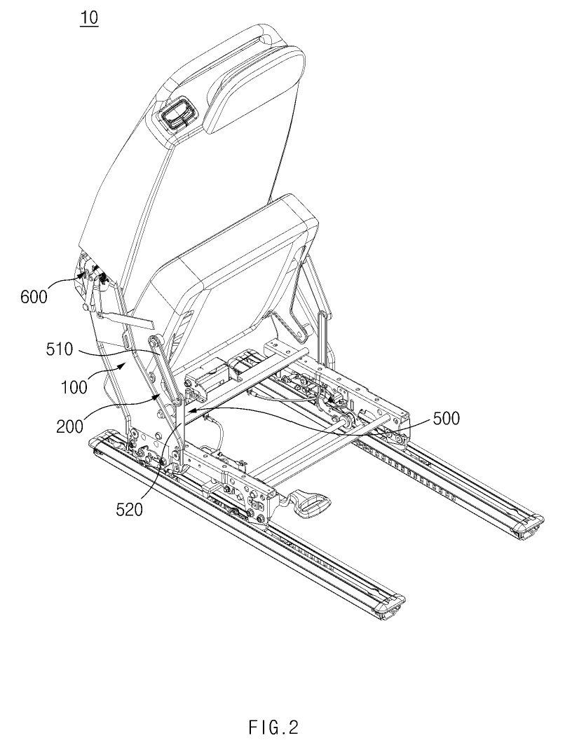

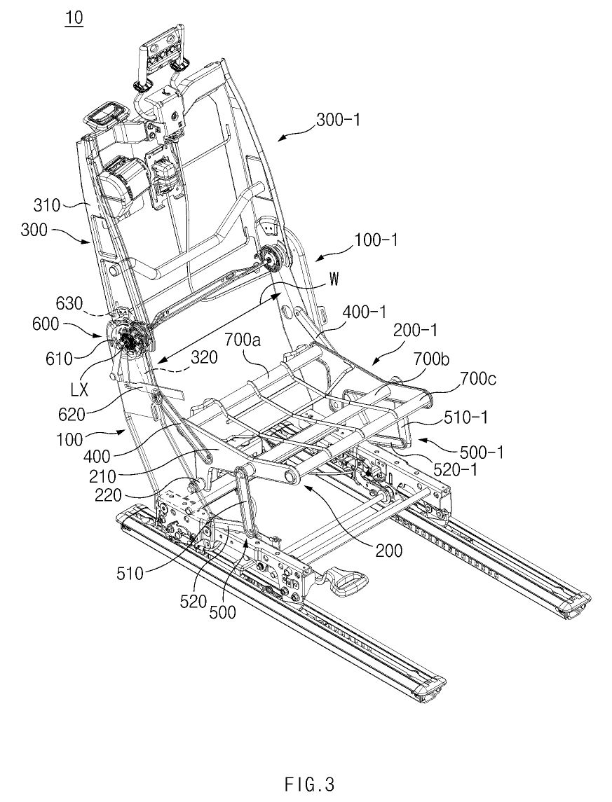

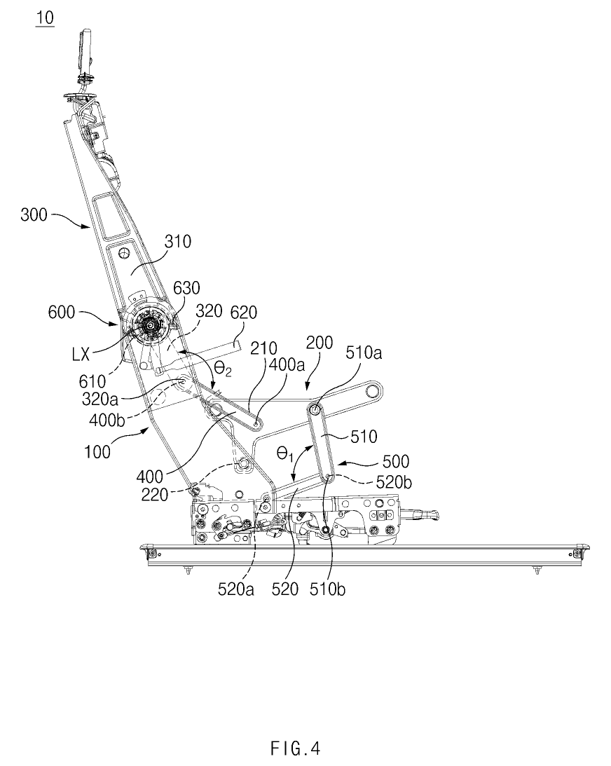

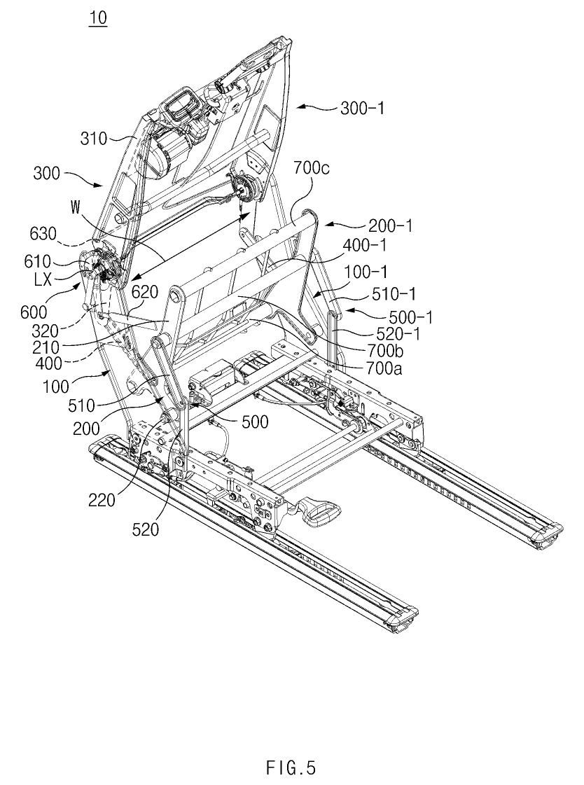

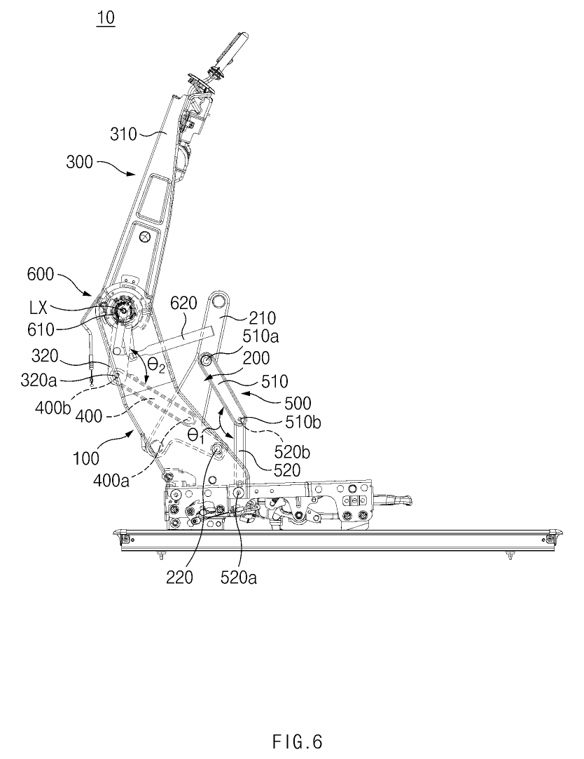

FIG. 1 is a perspective view of an example seat in a seating position. In FIG. 1, the seat may be in a state in which a user may be seated in the seat. FIG. 2 is a perspective view of an example seat in a folded position. In FIG. 2, the seat may be in a state where a cushion frame part is rotated so that the cushion frame part in FIG. 1 extends in an upward/downward direction (e.g., vertical direction). FIG. 3 is a perspective view illustrating a framework and links of an example seat in a seating position (e.g., in the state as shown in FIG. 1). FIG. 4 is a side view illustrating a positional relationship between a framework and links of an example seat is in a seating position (e.g., in the state as shown in FIG. 1). FIG. 5 is a perspective view illustrating a framework and links of an example in a folded position (e.g., in the state as shown in FIG. 2). FIG. 6 is a side view illustrating a positional relationship between a framework and links of an example seat in a folded position (e.g., in the state as shown in FIG. 2).

A seat 10 may be for a vehicle. Therefore, the term “ground surface” used herein may refer to a floor surface of the vehicle.

With reference to FIGS. 1-3, the seat 10 may include all or some of a leg frame part 100, a cushion frame part (also referred to as a cushion frame or a bottom seat frame) 200, a back frame part (also referred to as a top seat frame) 300, a connection link member (also referred to as a first connection link or linkage) 400, and a cushion link member (also referred to as a second connection link or linkage) 500.

The leg frame part 100 may protrude upward from the ground surface and be configured to fix the seat 10 to the ground surface. The leg frame part 100 may be, for example, one leg frame (e.g., a left leg frame or a right leg frame) of a leg frame assembly consisting of one or more leg frames (e.g., the leg frame part 100 and the leg frame part 100-1). For example, the leg frame part 100 may be relatively fixed to the ground surface. One side (e.g., a top portion) of the leg frame part 100 may be provided to overlap at least a part of the back frame part 300 to be described below when the seat 10 is viewed in a leftward/rightward direction (e.g., lateral direction) W.

The cushion frame part 200 may be rotatably provided at one side (e.g., a bottom portion) of the leg frame part 100. For example, at least a part of the cushion frame part 200 may be positioned in a central region of the leg frame part 100. With reference to FIGS. 1, 3, and 4, the cushion frame part 200 may be configured to constitute a frame of a cushion region in which a user's buttocks are seated when the user is seated in the seat 10.

The cushion frame part 200 may include both or one of a cushion frame body region 210 and a cushion frame hinge 220. The cushion frame hinge 220 may be a rotational axis (e.g., a hinge, a pivot, etc.) around which the cushion frame part 200 can rotate. The cushion frame body region 210 may be disposed to extend forward in case that the seat 10 is in a state (hereinafter, referred to as a “first state”) in which the user may be seated in the seat 10. The first state of the seat may also be referred to as an open position/configuration, unfolded position/configuration, deployed position/configuration, extended position/configuration, standard position/configuration, sitting position/configuration, etc. of the seat. The cushion frame body region 210 may be disposed to extend (e.g., be aligned) in an upward/downward direction (e.g., vertical direction) in a state (hereinafter, referred to as a “second state”) in which the cushion frame part 200 extends in the upward/downward direction. The second state may also be referred to as a closed position/configuration, folded position/configuration, stowed position/configuration, collapsed position/configuration, storage position/configuration, etc. of the seat. The cushion frame hinge 220 may extend from one side of the cushion frame body region 210. One side of the cushion frame hinge 220 may be provided to be rotatably coupled to the leg frame part 100 (e.g., to one of the leg frames of the leg frame part 100). The cushion frame hinge 220 may be positioned above and rearward of a first side 520a of a second cushion link to be described below.

The back frame part 300 may be rotatably coupled to the other side of the leg frame part 100. As illustrated in FIGS. 1, 3, and 4, in the first state, the back frame part 300 may be positioned rearward of the cushion frame part 200. In the present specification, a direction in which the user is directed when the user is seated in the seat 10 is defined as a forward direction, and a direction opposite to the forward direction is defined as a rearward direction. The back frame part 300 may be configured to constitute a frame of a backrest region in which the user's back is seated when the user is seated in the seat 10. As illustrated in FIGS. 2, 5, and 6, in the second state, the back frame part 300 may be inclined forward and upward and disposed to extend.

The back frame part 300 may include both or one of a back frame body region 310 and a back frame hinge 320. The back frame hinge 320 may also be referred to as a back frame extension or a back frame hinge assembly. The back frame hinge 320 may be, for example, an extension having a rotational axis (e.g., a hinge, a pivot, etc.) around which the connection link member 400 can rotate. The back frame body region 310 may be disposed so as not to overlap the leg frame part 100 when the seat 10 is viewed in the leftward/rightward direction W. The back frame hinge 320 may extend from an end of the back frame body region 310. A first side (also referred to as a first end portion) 320a of the back frame hinge may be rotatably coupled to the connection link member 400 to be described below. The back frame hinge 320 may be provided to overlap the leg frame part 100 when the seat 10 is viewed in the leftward/rightward direction W.

The cushion frame part 200 and the back frame part 300 may each be provided to be movable relative to the leg frame part 100. For example, the cushion frame part 200 and the back frame part 300 may move along predetermined trajectories relative to the leg frame part 100 by means of the connection link member 400 and the cushion link member 500. In particular, the movement of the cushion frame part 200 and the movement of the back frame part 300 may be restricted by the link members.

With reference to FIGS. 3 and 4, a first side of the connection link member 400 may be rotatably coupled to the cushion frame part 200, and a second side of the connection link member 400 may be rotatably coupled to the back frame part 300. More specifically, a first side (also referred to as a first end portion) 400a of the connection link member 400 may be rotatably coupled to the first side 320a of the back frame hinge.

The cushion link member 500 may be provided to be rotatably coupled to the leg frame part 100 and the cushion frame part 200. The cushion link member 500 may include both or one of a first cushion link 510 and a second cushion link 520. A first side (also referred to as a first end portion) 510a of the first cushion link 510 may be rotatably coupled to the cushion frame part 200, and a second side (also referred to as a second end portion) 510b of the first cushion link 510 may be rotatably coupled to the second cushion link 520. The first side 520a of the second cushion link 520 may be rotatably coupled to the leg frame part 100, and a second side (also referred to as a second end portion) 520b of the second cushion link 520 may be rotatably coupled to the first cushion link 510. However, unlike the configuration illustrated in the drawings, the cushion link member 500 may be substituted with a gas damper.

That is, the motion of the cushion frame part 200 and the motion of the back frame part 300 relative to the leg frame part 100 may be restricted by the connection between the connection link member 400, the first cushion link 510, and the second cushion link 520.

The seat 10 may further include a recliner part (also referred to as a recliner assembly) 600 configured to selectively fix (e.g., via detents) the back frame part 300. For example, the recliner part 600 may be configured to position the back frame part 300 at one of a plurality of reclined positions (e.g., rotative or angular positions) relative to the leg frame part 100. Each position of the plurality of reclined positions may be a locked position in which the back frame part 300 is locked at a fixed position (e.g., fixed angular position) relative to the leg frame part 100. For example, as illustrated in the drawings, the recliner part 600 may be provided in a region in which the back frame part 300 is rotatably connected to the leg frame part 100.For example, the recliner part 600 may be configured to reversibly and repeatedly switch between i) a state in which the back frame part 300 and the cushion frame part 200 are fixed to each other and ii) a state in which the back frame part 300 and the cushion frame part 200 are set to be rotatable relative to each other. However, unlike the configuration illustrated in the drawings, the recliner part 600 may be provided in another region as long as the region is a region in which the back frame part 300 and the cushion frame part 200 are coupled to be rotatable relative to each other in the seat 10. For example, the recliner part 600 may be provided in a region in which the first side 520a of the second cushion link is rotatably connected to the leg frame part 100. In addition, the recliner part 600 may be substituted with a locking member such as a latch member.

The recliner part 600 may include all or some of a recliner 610, a recliner lever 620, and a return spring 630. The recliner 610 may be provided in a region in which the back frame part 300 is rotatably connected to the leg frame part 100. That is, the recliner 610 may be disposed in a region of the leg frame part 100 to which the back frame part 300 is rotatably connected. For example, the back frame part 300 may rotate about a recliner rotation shaft LX.

The recliner lever 620 may be connected to the recliner 610 and configured to perform control to lock or unlock the recliner 610. That is, when the recliner lever 620 operates, the recliner 610 may be unlocked, and the back frame part 300 may rotate about the recliner rotation shaft LX.

The return spring 630 may rotate the back frame part 300 forward by means of an elastic force of the return spring 630.

Hereinafter, a shape and structure of the seat 10 when the seat 10 is in the first state will be described.

As illustrated in FIGS. 3 and 4, in a state in which the first cushion link 510 and the second cushion link 520 are rotated so that the seat is in the first state (e.g., the open position of the seat), the constituent elements may be disposed as follows.

In the relative positional relationship between the first cushion link 510 and the second cushion link 520, the first side 520a of the second cushion link may be positioned rearward of the first side 510a of the first cushion link.

In the relative positional relationship between the cushion link member 500 and the cushion frame hinge 220, the second side 510b of the first cushion link and the second side 520b of the second cushion link may be positioned below the cushion frame hinge 220 when the seat 10 is viewed in the leftward/rightward direction W.

In the relative positional relationship between the connection link member 400 and the first cushion link 510, the first side 400a of the connection link member may be positioned rearward of the first side 510a of the first cushion link.

In the relative positional relationship between the connection link member 400 and the leg frame part 100, the first side 400a of the connection link member may be provided to be spaced apart forward from (e.g., jut forward relative to) the leg frame part 100 (e.g., positioned at a more forward position relative to the leg frame part 100) when the seat 10 is viewed in the leftward/rightward direction W.

That is, an angle θ2 defined between the back frame hinge 320 and a straight line, which connects the first side 400a and a second side (also referred to as a second end portion) 400b of the connection link member, may be larger than an angle θ1 defined between a straight line, which connects the first side 510a and the second side 510b of the first cushion link, and a straight line that connects the first side 520a and the second side 520b of the second cushion link.

Hereinafter, a shape and structure of the seat 10 during a process in which the seat 10 switches from the first state to the second state will be described.

In the state in which the user may be seated in the seat 10 as illustrated in FIG. 3, the recliner lever 620 operates first and uncouples the recliner 610 to implement a state in which the cushion frame part 200 extends in the upward/downward direction, as illustrated in FIG. 5. Thereafter, when the back frame part 300 is rotated about the recliner rotation shaft LX by the return spring 630, the first side 320a of the back frame hinge and the second side 400b of the connection link member are rotated, and the cushion frame part 200 connected to the connection link member 400 is rotated rearward. Specifically, the cushion frame hinge 220 of the cushion frame part 200 is rotated rearward relative to the leg frame part 100 by the rotation of the connection link member 400, such that the cushion frame part 200 is rotated rearward. In addition, the first side 510a of the first cushion link, which is connected to the cushion frame part 200, rotates, the second side 520b of the second cushion link, which is connected to the first cushion link 510, rotates, and the first side 520a of the second cushion link, which is connected to the leg frame part 100, rotates, such that the components of the seat 10 are moved so that the cushion frame part 200 may relatively move along a predetermined trajectory.

The motion of the cushion frame part 200 and the motion of the back frame part 300 may operate in conjunction with each other by means of coupling structures between the frame parts and the links. In particular, if the seat 10 switches from the first state to the second state, the back frame part 300 may move forward, the cushion frame part 200 may stand in the upward/downward direction while moving rearward, and the back frame part 300 and the cushion frame part 200 may overlap each other in the forward/rearward direction, such that the space occupied by the seat 10 in the forward/rearward direction may be reduced or minimized. Therefore, in the case of the vehicle equipped with the seat 10, the utilization of the internal space may be maximized.

Hereinafter, a shape and structure of the seat 10 when the seat 10 is in the second state (e.g., the closed position) will be described.

As illustrated in FIGS. 5 and 6, in a state in which the first cushion link 510 and the second cushion link 520 are rotated so that the seat is in the second state, the constituent elements may be disposed as follows.

In the relative positional relationship between the first cushion link 510 and the second cushion link 520, the first side 520a of the second cushion link may be positioned forward of the first side 510a of the first cushion link.

In the relative positional relationship between the cushion link member 500 and the cushion frame hinge 220, the second side 510b of the first cushion link and the second side 520b of the second cushion link may be positioned above the cushion frame hinge 220 when the seat 10 is viewed in the leftward/rightward direction W.

In the relative positional relationship between the connection link member 400 and the first cushion link 510, the first side 400a of the connection link member may be positioned below the first side 510a of the first cushion link.

In the relative positional relationship between the connection link member 400 and the leg frame part 100, the first side 400a of the connection link member may be provided to overlap the leg frame part 100 when the seat 10 is viewed in the leftward/rightward direction W.

In the relative positional relationship between the back frame part 300 and the cushion frame part 200, the back frame part 300 and the cushion frame part 200 may be disposed to face each other, inclined forward and upward, and disposed to extend when the seat 10 is viewed in the leftward/rightward direction W.

That is, the angle θ2 defined between the back frame hinge 320 and the straight line, which connects the first side 400a and the second side 400b of the connection link member, may be smaller than the angle θ1 defined between the straight line, which connects the first side 510a and the second side 510b of the first cushion link, and the straight line that connects the first side 520a and the second side 520b of the second cushion link.

The seat 10 may include the components spaced apart from one another in the leftward/rightward direction (e.g., the lateral direction) W and corresponding to one another.

For example, the seat 10 may further include an additional leg frame part 100-1 spaced apart from the leg frame part 100 in the leftward/rightward direction (e.g., the lateral direction) W and corresponding to the leg frame part 100, an additional cushion frame part 200-1 spaced apart from the cushion frame part 200 in the leftward/rightward direction W, corresponding to the cushion frame part 200, and rotatably coupled to the additional leg frame part 100-1, and an additional back frame part 300-1 spaced apart from the back frame part 300 in the leftward/rightward direction W, corresponding to the back frame part 300, and configured to be rotatable relative to the additional leg frame part 100-1.

The above-mentioned descriptions of the leg frame part 100, the cushion frame part 200, and the back frame part 300 may also be basically and equally applied to the additional leg frame part 100-1, the additional cushion frame part 200-1, and the additional back frame part 300-1. Unlike the configuration illustrated in FIGS. 3 and 5, FIGS. 1, 2, 4, and 6 illustrate, for convenience of description, that the leg frame part 100 and the additional leg frame part 100-1 are integrated into a single component, the cushion frame part 200 and the additional cushion frame part 200-1 are integrated into a single component, and the back frame part 300 and the additional back frame part 300-1 are integrated into a single component.

The seat may further include an additional connection link member 400-1 having a first side (also referred to as a first end portion) rotatably coupled to the additional cushion frame part 200-1, and a second side (also referred to as a second end portion) rotatably coupled to the additional back frame part 300-1. In addition, the seat may further include an additional cushion link member 500-1 rotatably coupled to the additional leg frame part 100-1 and the additional cushion frame part 200-1.

The additional leg frame part 100-1, the additional cushion frame part 200-1, and the additional back frame part 300-1 may constitute a four-joint link together with the additional connection link member 400-1 and the additional cushion link member 500-1. The additional cushion link member 500-1 may include an additional first cushion link 510-1 and an additional second cushion link 520-1. Therefore, if the back frame part 300 and the cushion frame part 200 rotate as the user manipulates the recliner part 600 as described above, the additional cushion link member 500-1 may rotate while corresponding to the rotation.

In addition, the seat 10 may further include a shaft member configured to allow the motions of the cushion frame part 200 and the cushion link member 500 and the motions of the additional cushion frame part 200-1 and the additional cushion link member 500-1 to be performed in conjunction with one another. More specifically, the seat may further include a connection shaft member 700b extending in the leftward/rightward direction W and provided to sequentially penetrate the first cushion link 510, the cushion frame part 200, the additional cushion frame part 200-1, and the additional first cushion link 510-1. That is, the first cushion link 510, the cushion frame part 200, the additional cushion frame part 200-1, and the additional first cushion link 510-1 may rotate about the connection shaft member 700b. The seat may further include auxiliary connection shaft members 700a and 700c respectively disposed forward and rearward of the connection shaft member 700b and provided to penetrate the cushion frame part 200 and the additional cushion frame part 200-1. The auxiliary connection shaft members 700a and 700c may be disposed to assist the rotational motions of the cushion frame part 200 and the additional cushion frame part 200-1 together with the connection shaft member 700b and disperse a load applied during the rotation.

A seat may include, for example, a recliner that is configured to rotate, based on an elastic force, the back frame such that a first end portion of the back frame juts forward relative to a second end portion of the back frame. The back frame and the cushion frame may be coupled such that the rotation of the back frame causes a rotation of the cushion frame to dispose the back frame to be parallel to the cushion frame. The cushion link may include a gas damper.

A seat may include a leg frame. The seat may further include a cushion frame rotatably coupled to a first portion of the leg frame. The seat may further include a back frame rotatably coupled to a second portion of the leg frame. The seat may further include a connection link. The connection link may include a first end portion that is rotatably coupled to the cushion frame, and a second end portion that is rotatably coupled to the back frame. The seat may further include a cushion link that is rotatably coupled to the leg frame and the cushion frame. The back frame and the cushion frame may be coupled such that a rotation of the back frame causes a rotation of the cushion frame to dispose the back frame to be parallel to the cushion frame. The seat may further include a recliner that is configured to rotate, based on an elastic force, the back frame such that a first end portion of the back frame juts forward relative to a second end portion of the back frame.

In order to achieve the above-mentioned object, one aspect of the present disclosure provides a seat including: a leg frame part; a cushion frame part rotatably provided at one side of the leg frame part; a back frame part rotatably coupled to the other side of the leg frame part; a connection link member having a first side rotatably coupled to the cushion frame part, and a second side rotatably coupled to the back frame part; and a cushion link member rotatably coupled to the leg frame part and the cushion frame part.

The cushion frame part may include: a cushion frame body region; and a cushion frame hinge extending from one side of the cushion frame body region and having one side rotatably coupled to the leg frame part.

The cushion link member may include: a first cushion link having a first side rotatably coupled to the cushion frame part; and a second cushion link having a first side rotatably coupled to the leg frame part, and a second side rotatably coupled to the first cushion link.

The back frame part may further include: a back frame body region; and a back frame hinge extending from an end of the back frame body region and having one side rotatably coupled to the connection link member.

The first side of the second cushion link may be positioned rearward of the first side of the first cushion link in a state in which the first cushion link and the second cushion link are rotated so that the seat is in a state in which a user is capable of being seated in the seat.

The first side of the second cushion link may be positioned forward of the first side of the first cushion link in a state in which the first cushion link and the second cushion link are rotated so that the cushion frame part extends in an upward/downward direction.

A second side of the first cushion link and the second side of the second cushion link may be positioned below the cushion frame hinge when the seat is viewed in a leftward/rightward direction in a state in which the first cushion link and the second cushion link are rotated so that the seat is in a state in which a user is capable of being seated in the seat.

The second side of the first cushion link and the second side of the second cushion link may be positioned above the cushion frame hinge when the seat is viewed in the leftward/rightward direction in a state in which the first cushion link and the second cushion link are rotated so that the cushion frame part extends in an upward/downward direction.

The first side of the connection link member may be provided rearward of the first side of the first cushion link in a state in which the first cushion link and the second cushion link are rotated so that the seat is in a state in which a user is capable of being seated in the seat.

The first side of the connection link member may be positioned below the first side of the first cushion link in a state in which the first cushion link and the second cushion link are rotated so that the cushion frame part extends in an upward/downward direction.

The first side of the connection link may be spaced apart forward from the leg frame part when the seat is viewed in a leftward/rightward direction in a state in which the first cushion link and the second cushion link are rotated so that the seat is in a state in which a user is capable of being seated in the seat.

The first side of the connection link member may be provided to overlap the leg frame part when the seat is viewed in the leftward/rightward direction in a state in which the first cushion link and the second cushion link are rotated so that the cushion frame part extends in an upward/downward direction.

An angle θ2 defined between the back frame hinge and a straight line, which connects the first side and the second side of the connection link member, may be larger than an angle θ1 defined between a straight line, which connects the first side and a second side of the first cushion link, and a straight line, which connects the first side and the second side of the second cushion link, in a state in which the first cushion link and the second cushion link are rotated so that the seat is in a state in which a user is capable of being seated in the seat.

The angle θ2 defined between the back frame hinge and the straight line, which connects the first side and the second side of the connection link member, may be smaller than the angle θ1 defined between the straight line, which connects the first side and the second side of the first cushion link, and the straight line, which connects the first side and the second side of the second cushion link, in a state in which the first cushion link and the second cushion link are rotated so that the cushion frame part extends in an upward/downward direction.

The seat may further include: a recliner part configured to selectively fix the back frame part.

The recliner part may include: a recliner provided in a region to which the back frame part is rotatably connected; a recliner lever having one side coupled to the recliner and configured to be rotatable to unlock the recliner; and a return spring configured to provide an elastic force for rotating the back frame part forward.

The cushion frame hinge may be positioned above and rearward of the first side of the second cushion link.

The volume of the space occupied by the seat for a vehicle may be minimized, which may improve the utilization of the internal space of the vehicle.

The above description is simply given for illustratively describing the technical spirit of the present disclosure, and those skilled in the art to which the present disclosure pertains will appreciate that various changes and modifications are possible without departing from the essential characteristic of the present disclosure.

Therefore, the example embodiment(s) are provided for illustrative purposes only but not intended to limit the technical concept of the present disclosure. The scope of the technical concept of the present disclosure is not limited thereto. The protective scope of the present disclosure should be construed based on the following claims, and all the technical spirit in the equivalent scope thereto should be construed as falling within the scope of the present disclosure.

What is claimed is:

1. A seat comprising:
a leg frame;
a cushion frame rotatably coupled to a first portion of the leg frame;
a back frame rotatably coupled to a second portion of the leg frame;
a connection link comprising: a first side rotatably coupled to the cushion frame, and a second side rotatably coupled to the back frame; and
a cushion link rotatably coupled to the leg frame and the cushion frame.

2. The seat of claim 1, wherein the cushion frame comprises:
a cushion frame body region; and
a cushion frame hinge comprising:
a first end extending from a side of the cushion frame body region, and
a second end rotatably coupled to the leg frame.

3. The seat of claim 2, wherein the cushion link comprises:
a first cushion link comprising a first side rotatably coupled to the cushion frame; and
a second cushion link comprising:
a first side rotatably coupled to the leg frame, and
a second side rotatably coupled to the first cushion link.

4. The seat of claim 3, wherein the first cushion link and the second cushion link are configured to rotate such that, based on the seat being in an open position, the first side of the second cushion link is positioned rearward of the first side of the first cushion link.

5. The seat of claim 3, wherein the first cushion link and the second cushion link are configured to rotate such that, based on the seat being in a closed position, the first side of the second cushion link is positioned forward of the first side of the first cushion link

6. The seat of claim 3, wherein the first cushion link and the second cushion link are configured to rotate such that, based on the seat being in an open position, a second side of the first cushion link and the second side of the second cushion link are positioned below the cushion frame hinge, when the seat is viewed from a side..

7. The seat of claim 3, wherein the first cushion link and the second cushion link are configured to rotate such that, based on the seat being in a closed position, the second side of the first cushion link and the second side of the second cushion link are positioned above the cushion frame hinge, when the seat is viewed from a side.

8. The seat of claim 3, wherein the first cushion link and the second cushion link are configured to rotate such that, based on the seat being in an open position, the first side of the connection link is positioned rearward of the first side of the first cushion link.

9. The seat of claim 3, wherein the first cushion link and the second cushion link are configured to rotate such that, based on the seat being in a closed position, the first side of the connection link is positioned below the first side of the first cushion link .

10. The seat of claim 3, wherein the first cushion link and the second cushion link are configured to rotate such that, based on the seat being in an open position, the first side of the connection link is spaced forward from the leg frame, when the seat is viewed from a side.

11. The seat of claim 3, wherein the first cushion link and the second cushion link are configured to rotate such that, based on the seat being in a closed position, the first side of the connection link overlaps the leg frame, when the seat is viewed from a side.

12. The seat of claim 3, wherein the cushion frame hinge is positioned above and rearward of the first side of the second cushion link.

13. The seat of claim 3, wherein the back frame further comprises:
a back frame body region; and
a back frame extension that extends from an end portion of the back frame body region and comprises a hinge portion rotatably coupled to the connection link.

14. The seat of claim 13, wherein the first cushion link and the second cushion link are configured to rotate such that, based on the seat being in an open position, a first angle θ₂ between the back frame extension and a first line that connects the first side of the connection link and the second side of the connection link, is greater than a second angle θ₁ between a second line that connects the first side of the first cushion link and a second side of the first cushion link and a third line that connects the first side of the second cushion link and the second side of the second cushion link.

15. The seat of claim 13, wherein the first cushion link and the second cushion link are configured to rotate such that, based on the seat being in a closed position, a first angle θ₂ between the back frame extension and a first line that connects the first side of the connection link and the second side of the connection link, is less than a second angle θ₁ between a second line that connects the first side of the first cushion link and the second side of the first cushion link and a third line that connects the first side of the second cushion link and the second side of the second cushion link.

16. The seat of claim 1, further comprising:
a recliner assembly configured to selectively fix the back frame.

17. The seat of claim 16, wherein the recliner assembly comprises:
a recliner provided in a region to which the back frame is rotatably connected;
a recliner lever comprising a first end portion coupled to the recliner and configured to be rotatable to unlock the recliner; and
a return spring configured to provide an elastic force for rotating the back frame forward.

18. The seat of claim 1, further comprising:
a recliner configured to rotate, based on an elastic force, the back frame such that a first end portion of the back frame juts forward relative to a second end portion of the back frame,
wherein the back frame and the cushion frame are coupled such that the rotation of the back frame causes a rotation of the cushion frame to dispose the back frame parallel to the cushion frame, and
wherein the cushion link comprises a gas damper.

19. A seat comprising:
a leg frame;
a cushion frame rotatably coupled to a first portion of the leg frame;
a back frame rotatably coupled to a second portion of the leg frame;
a connection link comprising: a first side rotatably coupled to the cushion frame, and a second side rotatably coupled to the back frame; and
a cushion link rotatably coupled to the leg frame and the cushion frame,
wherein the back frame and the cushion frame are coupled such that a rotation of the back frame causes a rotation of the cushion frame to dispose the back frame parallel to the cushion frame.

20. The seat of claim 19, further comprising:
a recliner configured to rotate, based on an elastic force, the back frame such that a first end portion of the back frame juts forward relative to a second end portion of the back frame.
